(19) United States
(12) Patent Application Publication
(10) Pub. No.: US 2024/0308326 A1
(43) Pub. Date: Sep. 19, 2024

(54) DRIVE APPARATUS FOR VEHICLE

(71) Applicants: TOYOTA JIDOSHA KABUSHIKI KAISHA, Toyota-shi (JP); NSK LTD., Tokyo (JP)

(72) Inventors: Kazunori Sakai, Nagoya-shi (JP); Shinichiro Suenaga, Nagoya-shi (JP); Masayuki Ishibashi, Numazu-shi (JP); Hiroyasu Yoshioka, Fujisawa-shi (JP); Takahisa Nomoto, Fujisawa-shi (JP)

(73) Assignees: TOYOTA JIDOSHA KABUSHIKI KAISHA, Toyota-shi (JP); NSK LTD., Tokyo (JP)

(21) Appl. No.: 18/599,628

(22) Filed: Mar. 8, 2024

(30) Foreign Application Priority Data
Mar. 13, 2023 (JP) 2023-039159

(51) Int. Cl. B60K 6/40; B60K 6/48

(52) U.S. Cl. CPC B60K 6/40; B60K 6/48; B60K 2006/4816

(57) ABSTRACT

A ball bearing on one rotary shaft, out of a first rotary shaft and a second rotary shaft, on which a rotation member corresponding to a larger value of a ratio out of values of ratios of a rotation speed of a first rotation member and a rotation speed of a second rotation member relative to a rotation speed of a third rotation member is arranged does not include an inner race. Thereby, a ball PCD can be reduced while securing durability of a ball bearing on the one rotary shaft, and dragging loss between balls of the ball bearing and the inner race can be reduced. Since the ball bearing integrally configured with the rotary shaft is arranged on the one rotary shaft, reducing dragging loss of the ball bearing relatively largely reduces motive power loss on the third rotary shaft due to dragging loss of the ball bearing.

### CROSS-REFERENCE TO RELATED APPLICATION

This application claims priority to Japanese Patent Application No. 2023-039159 filed on Mar. 13, 2023, incorporated herein by reference in its entirety.

### BACKGROUND

### 1. Technical Field

The present disclosure relates to a drive apparatus for a vehicle including a plurality of rotary shafts.

### 2. Description of Related Art

There is well known a drive apparatus for a vehicle, including: a first rotary shaft to which motive power from a first motive power source is input; a second rotary shaft to which motive power from a second motive power source is input; a third rotary shaft that is coupled to drive wheels and to which each of the motive power from the first motive power source and the motive power from the second motive power source is transmitted; a first rotation member that is arranged on the first rotary shaft and outputs the motive power from the first motive power source to the third rotary shaft; a second rotation member that is arranged on the second rotary shaft and outputs the motive power from the second motive power source to the third rotary shaft; and a third rotation member that is arranged on the third rotary shaft and to which each of the motive power from the first rotation member and the motive power from the second rotation member is input, wherein a rotation speed of the third rotation member is decelerated relative to each of a rotation speed of the first rotation member and a rotation speed of the second rotation member. This is, for example, a hybrid drive apparatus disclosed in Japanese Unexamined Patent Application Publication No. 2013-166548 (JP 2013-166548 A). JP 2013-166548 A discloses that the hybrid drive apparatus includes an input shaft coupled to an engine, a shaft member coupled to a second motor, vehicle axles coupled to wheels, and bearings rotatably supporting each of the input shaft and the shaft member.

### SUMMARY

Now, there arises a request for improving energy efficiency of the drive apparatus for a vehicle. In order to improve the energy efficiency, for example, one can consider reducing losses due to sliding friction of bearings included in the drive apparatus for a vehicle. In the case of ball bearings, by reducing a ball pitch circle diameter (=ball PCD) to restrain a circumferential speed of ball revolving, a sliding speed between balls and inner races can be lowered, and the losses due to sliding friction can be reduced. However, there can occasionally be a case where reducing the ball PCD results in making the physical constitution of the ball bearings small, in other words, in making the rated load of the ball bearings small, and there is a concern that durability of the ball bearings is reduced. Therefore, the ball PCD can only be reduced within a range where the durability of the ball bearings can be secured, and this results in room for improvement in terms of improvement of the energy efficiency.

The present disclosure is devised in view of the aforementioned circumstances, and an object thereof is to provide a drive apparatus for a vehicle with which an effect of reducing the loss of a ball bearing can be obtained as much as possible while securing durability of the ball bearing.

The point of a first disclosure is in providing (a) a drive apparatus for a vehicle, including: a first rotary shaft to which motive power from a first motive power source is input; a second rotary shaft to which motive power from a second motive power source is input; a third rotary shaft that is coupled to drive wheels and to which each of the motive power from the first motive power source and the motive power from the second motive power source is transmitted; a first rotation member that is arranged on the first rotary shaft and outputs the motive power from the first motive power source to the third rotary shaft; a second rotation member that is arranged on the second rotary shaft and outputs the motive power from the second motive power source to the third rotary shaft; and a third rotation member that is arranged on the third rotary shaft and to which each of the motive power from the first rotation member and the motive power from the second rotation member is input, wherein a rotation speed of the third rotation member is decelerated relative to each of a rotation speed of the first rotation member and a rotation speed of the second rotation member, the drive apparatus further including: (b) a first ball bearing rotatably supporting the first rotary shaft; and (c) a second ball bearing rotatably supporting the second rotary shaft, wherein (d) a ball bearing on one rotary shaft, out of the first rotary shaft and the second rotary shaft, on which a rotation member that corresponds to a larger value of a ratio out of a value of a ratio of the rotation speed of the first rotation member relative to the rotation speed of the third rotation member and a value of a ratio of the rotation speed of the second rotation member relative to the rotation speed of the third rotation member is arranged does not include an inner race, a function of a groove of the inner race is provided on the one rotary shaft, and balls are in contact with the one rotary shaft.

According to the first disclosure, the ball bearing on the one rotary shaft, out of the first rotary shaft and the second rotary shaft, on which the rotation member that corresponds to the larger value of the ratio relative to the rotation speed of the third rotation member out of the rotation speed of the first rotation member and the rotation speed of the second rotation member is arranged does not include the inner race. In other words, for the ball bearing on the one rotary shaft, the function of the groove of the inner race is provided on the one rotary shaft, and the balls are brought into contact with the one rotary shaft. Thereby, the ball PCD may be reduced while securing durability of the ball bearing on the one rotary shaft, and a dragging loss between the balls of the ball bearing and the inner race may be reduced. Moreover, since the ball bearing that is integrally configured with the rotary shaft is arranged on the one rotary shaft, reducing the dragging loss of the ball bearing relatively largely reduces a motive power loss on the third rotary shaft due to the dragging loss of the ball bearing. Therefore, the effect of reducing the loss of a ball bearing may be obtained as much as possible while securing durability of the ball bearing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining an example of a schematic configuration of a vehicle to which the present disclosure is applied;

FIG. 2 is a diagram for explaining an example of an electric configuration of an electric circuit unit and the like;

FIG. 3A is a diagram for explaining an example of reducing a loss of a ball bearing, being a diagram showing a structure of a known ball bearing;

FIG. 3B is a diagram for explaining an example of reducing the loss of a ball bearing, being a diagram showing a structure of a shaft-integrated ball bearing;

FIG. 4 is a diagram for explaining an example of arrangement positions of constituting members of a drive apparatus;

FIG. 5 is a diagram for explaining an example of a schematic configuration of a mechatronic integrated unit; and

FIG. 6 is a diagram for explaining an example of a state where the mechatronic integrated unit is mounted on the vehicle.

### DETAILED DESCRIPTION OF EMBODIMENTS

Hereafter, an embodiment of the present disclosure is described in detail with reference to the drawings.

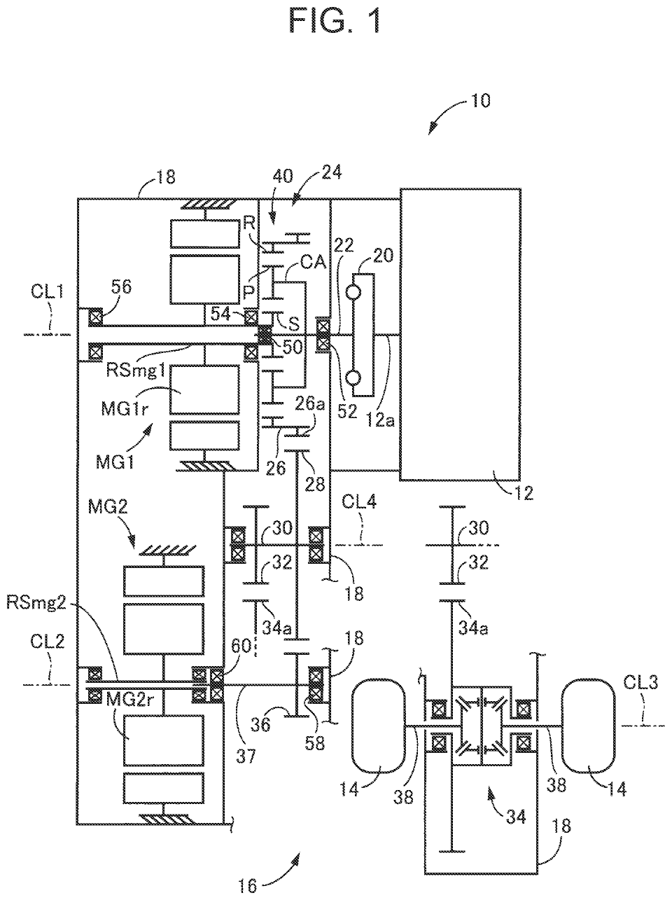

FIG. 1 is a diagram for explaining an example of a schematic configuration of a vehicle 10 to which the present disclosure is applied. In FIG. 1, the vehicle 10 includes an engine 12, drive wheels 14, and a drive apparatus 16. The engine 12 is a known internal combustion engine. The drive apparatus 16 includes a first motor MG1 and a second motor MG2, and is a drive apparatus for a vehicle which apparatus transmits motive power of each of the engine 12 and the second motor MG2 to the drive wheels 14. The vehicle 10 is an electrified vehicle that includes the engine 12 and the second motor MG2 functioning as motive power sources, in particular, a hybrid electric vehicle. The engine 12 is a first motive power source, and the second motor MG2 is a motor functioning as a second motive power source.

Each of the first motor MG1 and the second motor MG2 is a known electric rotation machine that has a function as a motor that generates mechanical motive power from electric power and a function as a generator that generates electric power from mechanical motive power, and is what is called a motor-generator. The first motor MG1 and the second motor MG2 are provided in a non-rotatable casing 18 that is a non-rotation member attached to a vehicle body.

The drive apparatus 16 includes a damper 20, an input shaft 22, a transmission unit 24, a combined gear 26, a driven gear 28, a counter shaft 30, a final gear 32, differential gears 34, a reduction gear 36, and the like in the casing 18. The drive apparatus 16 includes a rotor shaft RSmg1 integrally coupled to a rotor MG1r of the first motor MG1, and a rotor shaft RSmg2 integrally coupled to a rotor MG2r of the second motor MG2, in the casing 18. Moreover, the drive apparatus 16 includes a rotor coupling shaft 37 relatively non-rotatably coupled to the rotor shaft RSmg2 by spline fitting. The rotor coupling shaft 37 is coupled to the rotor MG2r of the second motor MG2. Moreover, the drive apparatus 16 includes a pair of driving axles 38 and the like coupled to the differential gears 34.

The input shaft 22 functions as an input rotation member of the transmission unit 24 and is coupled to a crankshaft 12a of the engine 12 via the damper 20 and the like. The transmission unit 24 is coupled to the input shaft 22. The combined gear 26 is a rotary body on the output side of the transmission unit 24. The combined gear 26 has a drive gear 26a formed on a part of its outer circumferential surface. The drive gear 26a is an output gear functioning as an output rotation member of the transmission unit 24. The reduction gear 36 has a smaller diameter than the driven gear 28. The reduction gear 36 is a deceleration gear relatively non-rotatably fixed to the rotor coupling shaft 37. Each of the driven gear 28 and the final gear 32 is relatively non-rotatably fixed to the counter shaft 30. The driven gear 28 is a first gear that meshes with each of the drive gear 26a and the reduction gear 36. The final gear 32 has a smaller diameter than the driven gear 28 and is a second gear that meshes with a differential ring gear 34a of the differential gears 34. The differential ring gear 34a is an input gear functioning as an input rotation member of the differential gears 34. The driving axle 38 is an output shaft functioning as an output rotation member of the differential gears 34.

The drive apparatus 16 configured as above may be suitably used for a vehicle in a front engine front-wheel drive (FF) system or a rear engine rear-wheel drive (RR) system. The drive apparatus 16 transmits motive power output from the engine 12 to the driven gear 28 via the transmission unit 24. Moreover, the drive apparatus 16 transmits motive power output from the second motor MG2 to the driven gear 28 via the reduction gear 36. The drive apparatus 16 transmits the motive power transmitted to the driven gear 28 to the drive wheels 14 sequentially via the counter shaft 30, the final gear 32, the differential gears 34, the driving axles 38, and the like.

The driven gear 28, the counter shaft 30, and the final gear 32 constitute a transmission apparatus for transmitting each of the motive power from the drive gear 26a and the motive power from the reduction gear 36 to the differential ring gear 34a. The differential gears 34 constitute a differential apparatus that distributes, to the drive wheels 14, the motive power transmitted from each of the engine 12 and the second motor MG2.

The transmission unit 24 includes the first motor MG1, the rotor shaft RSmg1, and a planetary gear apparatus 40. The planetary gear apparatus 40 is a known single pinion-type planetary gear apparatus including a sun gear S, a carrier CA, a ring gear R, and pinions P. The sun gear S is coupled to the rotor shaft RSmg1 so as to be able to transmit motive power. In other words, the sun gear S is coupled such that the first motor MG1 transmits motive power. The carrier CA is coupled to the input shaft 22 so as to be able to transmit motive power. In other words, the carrier CA is coupled such that the engine 12 can transmit motive power via the input shaft 22 and the like. The ring gear R is formed on a part of an inner circumferential surface of the combined gear 26, and integrally coupled to the drive gear 26a. In other words, the ring gear R is coupled so as to be able to transmit motive power to the drive wheels 14. Each pinion P is supported by the carrier CA so as to be able to rotate on its own axis and able to revolve. The ring gear R meshes with the sun gear S via the pinions P.

The planetary gear apparatus 40 is a differential mechanism that is coupled such that the engine 12 can transmit motive power and that generates differential operation. The first motor MG1 is a motor for differential coupled to the planetary gear apparatus 40 so as to be able to transmit motive power. The planetary gear apparatus 40 is a power split device that mechanically splits the motive power, of the engine 12, which is input to the carrier CA between the first motor MG1 and the drive gear 26a. The transmission unit 24 is a known electric transmission mechanism in which the differential state of the planetary gear apparatus 40 is controlled by the operation state of the first motor MG1 being controlled.

The drive apparatus 16 has a first axis line CL1, a second axis line CL2, a third axis line CL3, and a fourth axis line CL4. These four axis lines CL1, CL2, CL3, and CL4 are parallel to one another.

The input shaft 22 is a first rotary shaft to which the motive power from the engine 12 is input. The first axis line CL1 is an axial center of the input shaft 22. The first axis line CL1 is also an axial center of the rotor shaft RSmg1. The transmission unit 24 and the first motor MG1 are arranged around the first axis line CL1. The transmission unit 24 is arranged on the input shaft 22. The drive gear 26a is a first rotation member that is arranged on the input shaft 22 and outputs the motive power from the engine 12 to the driving axles 38.

The rotor coupling shaft 37 is a second rotary shaft to which the motive power from the second motor MG2 is input. The second axis line CL2 is an axial center of the rotor shaft RSmg2 of the second motor MG2. The second axis line CL2 is also an axial center of the rotor coupling shaft 37. The second motor MG2 and the reduction gear 36 are arranged around the second axis line CL2. The reduction gear 36 is a second rotation member that is arranged on the rotor coupling shaft 37 and outputs the motive power from the second motor MG2 to the driving axles 38.

The driving axle 38 is a third rotary shaft that is coupled to the drive wheels 14 and to which each of the motive power from the engine 12 and the motive power from the second motor MG2 is transmitted. The third axis line CL3 is an axial center of the driving axle 38. The third axis line CL3 is also an axial center of the differential gears 34. The differential gears 34 are arranged around the third axis line CL3. The differential ring gear 34a is a third rotation member that is arranged on the driving axle 38 and to which each of the motive power from the drive gear 26a and the motive power from the reduction gear 36 is input. A rotation speed of the differential ring gear 34a is decelerated relative to each of a rotation speed of the drive gear 26a and a rotation speed of the reduction gear 36.

The counter shaft 30 is a fourth rotary shaft. The fourth axis line CL4 is an axial center of the counter shaft 30. The driven gear 28 and the final gear 32 are arranged around the fourth axis line CL4.

The drive apparatus 16 includes a needle bearing 50. The input shaft 22 and the rotor shaft RSmg1 are relatively rotatably coupled via the needle bearing 50. Moreover, the drive apparatus 16 includes first axis ball bearings 52, 54, 56. The first axis ball bearing 52 is a first ball bearing that rotatably supports the input shaft 22 relative to the casing 18. The first axis ball bearings 54, 56 are bearings that rotatably support the rotor shaft RSmg1 relative to the casing 18. The input shaft 22 is supported by the first axis ball bearings 54, 56 via the rotor shaft RSmg1. The first axis ball bearing 54, 56 functions as a first ball bearing that rotatably supports the input shaft 22 via the rotor shaft RSmg1 relative to the casing 18. Moreover, the drive apparatus 16 includes second axis ball bearings 58, 60. The second axis ball bearings 58, 60 are second ball bearings that rotatably support the rotor coupling shaft 37 relative to the casing 18.

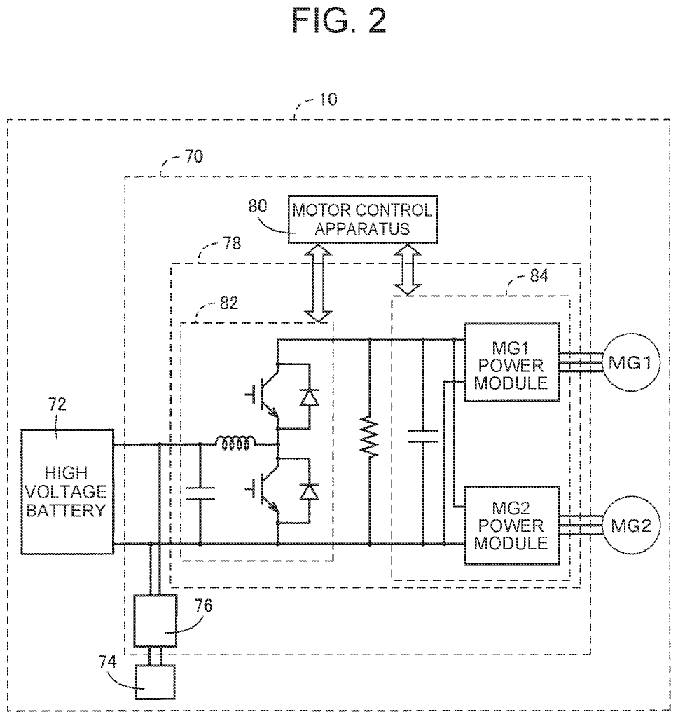

FIG. 2 is a diagram for explaining an example of an electric configuration of an electric circuit unit 70 and the like. In FIG. 2, the vehicle 10 further includes the electric circuit unit 70, a high voltage battery 72, an auxiliary battery 74, and the like. The electric circuit unit 70 constitutes a part of the drive apparatus 16 and individually controls the first motor MG1 and the second motor MG2.

The high voltage battery 72 is a chargeable-dischargeable DC power supply, for example, a secondary battery such as a nickel-metal hydride secondary battery or a lithium-ion battery. The high voltage battery 72 is connected to the electric circuit unit 70.

From the high voltage battery 72, electric power stored is supplied to the first motor MG1 and the second motor MG2 via the electric circuit unit 70. Moreover, to the high voltage battery 72, electric power by power generating control of the first motor MG1 and electric power by regenerative control of the second motor MG2 are supplied via the electric circuit unit 70. The high voltage battery 72 is a battery for drive.

The electric circuit unit 70 includes a DC-DC converter 76, an electric power control circuit 78, a motor control apparatus 80, and the like.

The DC-DC converter 76 is connected to the high voltage battery 72. The DC-DC converter 76 functions as a charging apparatus that steps down a voltage of the high voltage battery 72 to an equivalent voltage to that of the auxiliary battery 74 to charge the auxiliary battery 74. The auxiliary battery 74 supplies electric power for operating an auxiliary included in the vehicle 10. The auxiliary battery 74 supplies electric power for operating an electronic control apparatus such as the motor control apparatus 80 included in the vehicle 10.

The electric power control circuit 78 includes a boosting converter 82, an inverter 84, and the like. The electric power control circuit 78 controls the electric power transmitted and received between the high voltage battery 72 and each of the first motor MG1 and the second motor MG2.

The motor control apparatus 80 controls the boosting converter 82 and the inverter 84. For example, the motor control apparatus 80 converts a DC current from the high voltage battery 72 into an AC current used for each of the first motor MG1 and the second motor MG2. The motor control apparatus 80 drives the first motor MG1 for securing a power generation amount required for electric power supply to the second motor MG2 and charging of the high voltage battery 72. The motor control apparatus 80 drives the second motor MG2 based on an output requested value in accordance with a driver's requested torque. The motor control apparatus 80 causes the second motor MG2 to function as a generator in accordance with a requested amount of a regenerative brake.

Here, in order to improve energy efficiency for the drive apparatus 16, one can consider reducing losses due to sliding friction of the first axis ball bearings 52, 54, 56 and the second axis ball bearings 58, 60, for example. For a ball bearing, reducing a ball PCD can reduce a loss due to sliding friction. Nevertheless, reducing the ball PCD makes the physical constitution of the ball bearing small, and there is a concern that this causes durability of the ball bearing to be reduced. Therefore, it is desirable to enable the effect of reducing the loss of a ball bearing to be obtained as much as possible while securing durability of the ball bearing.

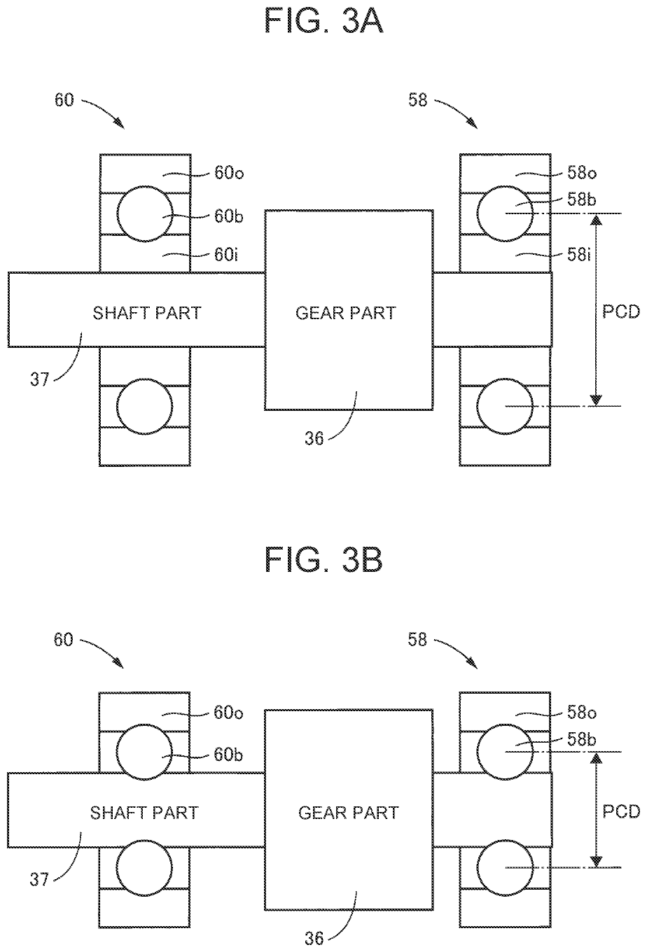

FIG. 3A and FIG. 3B are diagrams for explaining an example of reducing the loss of a ball bearing. FIG. 3A is a diagram showing structures of known ball bearings. FIG. 3B is a diagram showing structures of shaft-integrated ball bearings. In each of FIG. 3A and FIG. 3B, a “gear part” in the figure is the reduction gear 36, for example, and a “shaft part” is the rotor coupling shaft 37, for example. In FIG. 3A, the second axis ball bearing 58, 60 is a ball bearing having a known structure and including an inner race 58i, 60i, an outer race 58o, 60o, and balls 58b, 60b. Meanwhile, in FIG. 3B, the second axis ball bearing 58, 60 is a ball bearing from which the inner race 58i, 60i is eliminated and that has a structure in which the balls 58b, 60b roll on the rotor coupling shaft 37. In other words, the second axis ball bearings 58, 60 in FIG. 3B have shaft-integrated structures. As compared with the second axis ball bearing 58, 60 in FIG. 3A, the second axis ball bearing 58, 60 in FIG. 3B can reduce the ball PCD, and dragging losses of the balls 58b, 60b can be reduced. Thereby, friction loss torque ΔTf due to the balls 58b, 60b on the rotor coupling shaft 37 can be reduced.

The friction loss torque ΔTf on the shaft where ball bearings are arranged is increased by a reduction ratio ρ to appear as loss torque ΔTd (=ΔTf×ρ) on the driving axles 38. The reduction ratio ρ on a rotation member is a value of a ratio of a rotation speed of the rotation member relative to the rotation speed of the differential ring gear 34a. The reduction ratio ρ on the drive gear 26a is a value of a ratio of the rotation speed of the drive gear 26a relative to the rotation speed of the differential ring gear 34a. The reduction ratio ρ on the reduction gear 36 is a value of a ratio of the rotation speed of the reduction gear 36 relative to the rotation speed of the differential ring gear 34a.

Although, as the reduction ratio ρ is higher, the loss torque ΔTd becomes larger, a decrease in friction loss torque ΔTf also becomes larger, and hence, an effect of reducing the friction loss torque ΔTf becomes larger. In the drive apparatus 16, a shaft-integrated structure is employed for a ball bearing on one rotary shaft, out of the input shaft 22 and the rotor coupling shaft 37, on which the rotation member that corresponds to the larger reduction ratio ρ out of the reduction ratio ρ on the drive gear 26a and the reduction ratio ρ on the reduction gear 36 is arranged. The shaft-integrated structure for a ball bearing on the one rotary shaft is a structure that does not include an inner race and in which a function of the groove of the inner race is provided on the one rotary shaft and the balls are in contact with the one rotary shaft.

The reduction ratio ρ on the drive gear 26a is a product value of a reduction ratio ρ between the drive gear 26a and the driven gear 28 and a reduction ratio ρ between the final gear 32 and the differential ring gear 34a. Meanwhile, the reduction ratio ρ on the reduction gear 36 is a product value of a reduction ratio ρ between the reduction gear 36 and the driven gear 28 and the reduction ratio ρ between the final gear 32 and the differential ring gear 34a. For the drive apparatus 16, the reduction ratio ρ between the reduction gear 36 and the driven gear 28 is set to take a larger value than the reduction ratio ρ between the drive gear 26a and the driven gear 28. Accordingly, the one rotary shaft of the input shaft 22 and the rotor coupling shaft 37 is the rotor coupling shaft 37 on which the reduction gear 36 is arranged. The ball bearing for which the shaft-integrated structure is employed is the second axis ball bearing 58, 60.

By the ball bearing employing the shaft-integrated structure, a distance between the shaft on which the ball bearing with the shaft-integrated structure is arranged and another shaft that is coupled via a pair of gears becomes shorter by an amount of elimination of the inner race. Therefore, by the shaft on which the ball bearing with the shaft-integrated structure is arranged being arranged uppermost in the vertical direction, the height of the drive apparatus 16 can be made shorter by the height of the inner race to make the drive apparatus 16 compact. In the drive apparatus 16, in the mount state on the vehicle 10, that is, in a vehicle-mounted state, the one rotary shaft out of the input shaft 22 and the rotor coupling shaft 37 is arranged uppermost in the vertical direction among the input shaft 22, the rotor coupling shaft 37, and the driving axles 38. In particular, in the vehicle-mounted state, the rotor coupling shaft 37 is arranged uppermost in the vertical direction among the input shaft 22, the rotor coupling shaft 37, the driving axles 38, and the counter shaft 30.

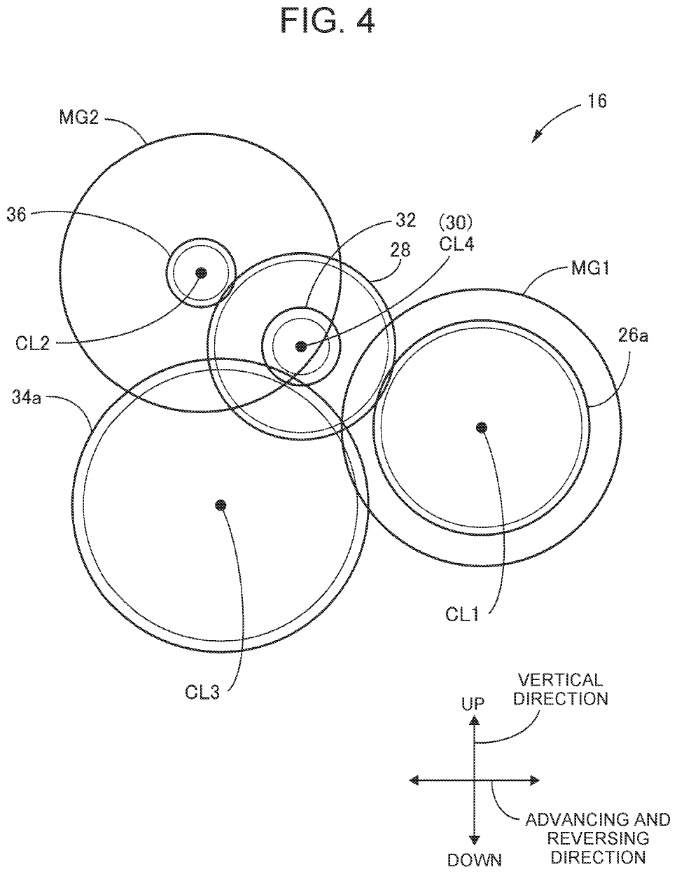

FIG. 4 is a diagram for explaining an example of arrangement positions of constituting members of the drive apparatus 16. In FIG. 4, in the vehicle-mounted state, in the drive apparatus 16, each of the first axis line CL1, the second axis line CL2, the third axis line CL3, and the fourth axis line CL4 is arranged to be parallel to the horizontal direction that is perpendicular to the advancing and reversing direction of the vehicle 10. Moreover, in the vehicle-mounted state, in the drive apparatus 16, positions of the first axis line CL1, the second axis line CL2, the third axis line CL3, and the fourth axis line CL4 are in the order of the second axis line CL2, the fourth axis line CL4, the first axis line CL1, and the third axis line CL3 from the above to the below in the vertical direction. In other words, in the vehicle-mounted state, in the drive apparatus 16, the rotor coupling shaft 37 is arranged uppermost in the vertical direction among the input shaft 22, the rotor coupling shaft 37, the driving axles 38, and the counter shaft 30. Thereby, the physical constitution of the drive apparatus 16 in the vertical direction is reduced. Note that the vertical direction and the advancing and reversing direction in the figure are directions in the vehicle-mounted state.

By the physical constitution of the drive apparatus 16 in the vertical direction being reduced, there arises a space above the second motor MG2 in the vertical direction. A structure and a type of a device that thereby can be mounted above the drive apparatus 16 are restrained from being limited.

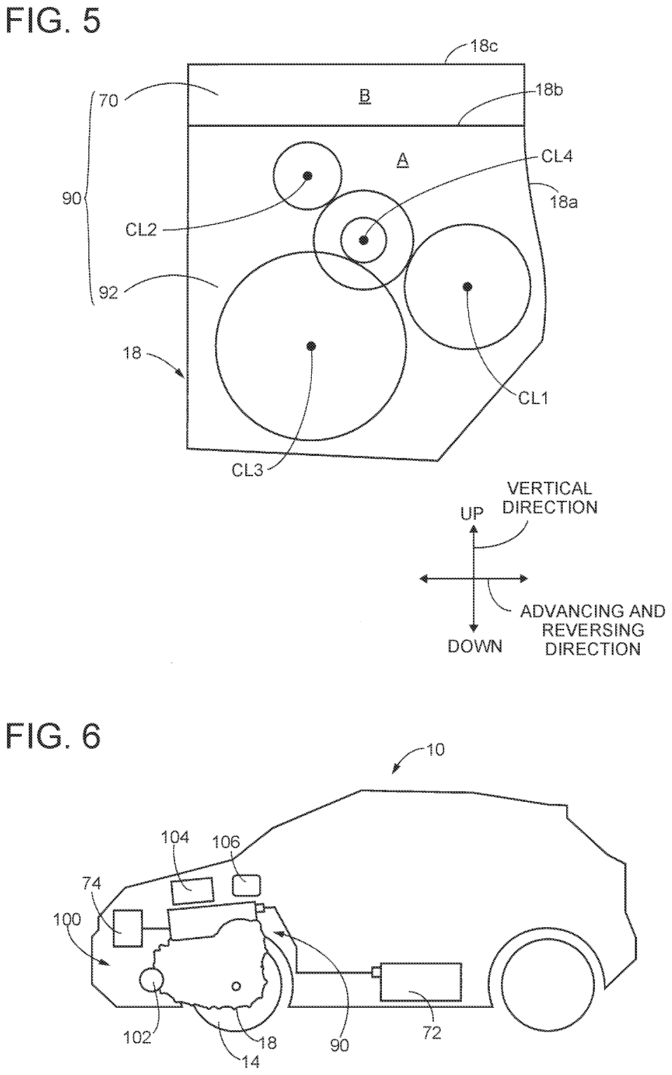

FIG. 5 is a diagram for explaining an example of a schematic configuration of a mechatronic integrated unit 90. In FIG. 5, the casing 18 houses, as the mechatronic integrated unit 90, a mechanical transmission unit 92 and the electric circuit unit 70. The mechanical transmission unit 92 constitutes a part of the drive apparatus 16. The mechanical transmission unit 92 includes the transmission unit 24 (the first motor MG1, the rotor shaft RSmg1, the input shaft 22, the planetary gear apparatus 40, and the like), the second motor MG2, the driven gear 28, the counter shaft 30, the final gear 32, the differential gears 34, the reduction gear 36, and the like.

For example, the casing 18 includes a body 18a, a cover plate 18b, and a protection cover 18c. The body 18a has a bottom wall and a sidewall extending upward in the vertical direction from the outer peripheral edge of the bottom wall, and opens at its vertical-directional upper portion. The cover plate 18b is a plate-like member closing a part of the opening of the body 18a. The protection cover 18c is provided on a vertical-directional upper face of the cover plate 18b. The body 18a forms a space A along with a lower surface of the cover plate 18b. The protection cover 18c forms a space B along with an upper surface of the cover plate 18b.

In the vehicle-mounted state, the mechanical transmission unit 92 is housed in the space A in a vertical-directional lower portion of the casing 18. In the vehicle-mounted state, the electric circuit unit 70 is housed in the space B in a vertical-directional upper portion of the casing 18.

By the vertical-directional physical constitution of the drive apparatus 16 being reduced, in particular, by the vertical-directional physical constitution of the mechanical transmission unit 92 being reduced, the vertical-directional physical constitution of the mechatronic integrated unit 90 is reduced. This forms a space above the mechatronic integrated unit 90 in the vertical direction.

FIG. 6 is a diagram for explaining an example of a state where the mechatronic integrated unit 90 is mounted on the vehicle 10. In FIG. 6, the casing 18 housing the mechatronic integrated unit 90 is arranged in an engine compartment 100. The engine compartment 100 is a motive power source chamber that houses the engine 12. In the engine compartment 100, for example, the auxiliary battery 74, a water pump 102, an air cleaner 104, a reservoir tank 106, and the like are also arranged. In particular, the air cleaner 104 and the reservoir tank 106 are arranged in the space formed above the mechatronic integrated unit 90 in the vertical direction. The high voltage battery 72 is arranged below a room space of the vehicle 10.

As mentioned above, according to the present embodiment, the shaft-integrated structure is employed for the ball bearing on the one rotary shaft, out of the input shaft 22 and the rotor coupling shaft 37, on which the rotation member that corresponds to the larger reduction ratio ρ out of the reduction ratio ρ on the drive gear 26a and the reduction ratio ρ on the reduction gear 36 is arranged. This can reduce the ball PCD while securing durability of the ball bearing on the one rotary shaft, and can reduce a dragging loss between balls of the ball bearing and an inner race. Moreover, since the ball bearing configured into the shaft-integrated structure is arranged on the one rotary shaft, a decrease in dragging loss of the ball bearing relatively largely reduces the loss torque ΔTd on the driving axles 38 due to the dragging loss of the ball bearing. Therefore, the effect of reducing the loss of a ball bearing can be obtained as much as possible while securing durability of the ball bearing.

Moreover, according to the present embodiment, since in the vehicle-mounted state, the one rotary shaft is arranged uppermost in the vertical direction among the input shaft 22, the rotor coupling shaft 37, and the driving axles 38, the height of the drive apparatus 16 is made shorter by the height of the inner race. In other words, the drive apparatus 16 can be made compact. Thereby, the structure and the type of a device that is mounted above the drive apparatus 16 are restrained from being limited.

Moreover, according to the present embodiment, since the one rotary shaft is the rotor coupling shaft 37, a decrease in dragging losses of the second axis ball bearings 58, 60 relatively largely reduces the loss torque ΔTd on the driving axles 38 due to the dragging losses of the second axis ball bearings 58, 60.

Moreover, according to the present embodiment, in the vehicle-mounted state, the rotor coupling shaft 37 is arranged uppermost in the vertical direction among the input shaft 22, the rotor coupling shaft 37, the driving axles 38, and the counter shaft 30. Thereby, the height of the drive apparatus 16 is made shorter by the height of the inner races that are eliminated from the second axis ball bearings 58, 60.

Moreover, according to the present embodiment, the drive apparatus 16 includes the driven gear 28 which is relatively non-rotatably fixed to the counter shaft 30 and meshes with each of the drive gear 26a and the reduction gear 36, and the final gear 32 which has a smaller diameter than the driven gear and meshes with the differential ring gear 34a. Thereby, the rotation speed of the differential ring gear 34a is appropriately decelerated relative to each of the rotation speed of the drive gear 26a and the rotation speed of the reduction gear 36.

While an embodiment of the present disclosure has been described in detail based on the drawings as above, the present disclosure is also applied in other aspects.

For example, in the aforementioned embodiment, the vehicle 10 is a hybrid electric vehicle including the engine 12, the first motor MG1, and the second motor MG2, not being limited to this aspect. For example, the present disclosure can be applied even to a hybrid electric vehicle including an engine and a motor. In this case, for example, in the arrangement positions of the constituting members of the drive apparatus 16 shown in FIG. 4, the first motor MG1 is replaced by the engine, and the second motor MG2 is replaced by the motor. In this stage, a transmission may be arranged around the fourth axis line CL4. Otherwise, motive power of the engine and the motor may be transmitted not via a transmission apparatus arranged around the fourth axis line CL4. In this case, the fourth axis line CL4 and the transmission apparatus around fourth axis line CL4 are not needed.

Moreover, in the aforementioned embodiment, the electric circuit unit 70 is

housed as the mechatronic integrated unit 90 together with the mechanical transmission unit 92 in the casing 18, not being limited to this aspect. For example, the electric circuit unit 70 may be housed in a separate casing from the casing having the mechanical transmission unit 92 housed. In this case, the electric circuit unit 70 may be arranged above the mechanical transmission unit 92 in the vertical direction or may be arranged at another position different from that above the mechanical transmission unit 92 in the vertical direction.

Moreover, in the aforementioned embodiment, the vehicle 10 may be what is called a plug-in hybrid electric vehicle having the high voltage battery 72 rechargeable with electric power from an external power supply. For such a plug-in hybrid electric vehicle, the drive apparatus 16 being made compact can increase flexibility in arrangement positions of a charger and the like.

Note that the above is merely an embodiment, and the present disclosure can be implemented in aspects with various modifications and improvements based on knowledge of the skilled in the art.

What is claimed is:

1. A drive apparatus for a vehicle, comprising:
a first rotary shaft to which motive power from a first motive power source is input;
a second rotary shaft to which motive power from a second motive power source is input;
a third rotary shaft that is coupled to drive wheels and to which each of the motive power from the first motive power source and the motive power from the second motive power source is transmitted;
a first rotation member that is arranged on the first rotary shaft and outputs the motive power from the first motive power source to the third rotary shaft;
a second rotation member that is arranged on the second rotary shaft and outputs the motive power from the second motive power source to the third rotary shaft; and
a third rotation member that is arranged on the third rotary shaft and to which each of the motive power from the first rotation member and the motive power from the second rotation member is input, wherein
a rotation speed of the third rotation member is decelerated relative to each of a rotation speed of the first rotation member and a rotation speed of the second rotation member, the drive apparatus further comprising:
a first ball bearing rotatably supporting the first rotary shaft; and
a second ball bearing rotatably supporting the second rotary shaft, wherein
a ball bearing on one rotary shaft, out of the first rotary shaft and the second rotary shaft, on which a rotation member that corresponds to a larger value of a ratio out of a value of a ratio of the rotation speed of the first rotation member relative to the rotation speed of the third rotation member and a value of a ratio of the rotation speed of the second rotation member relative to the rotation speed of the third rotation member is arranged does not include an inner race, a function of a groove of the inner race is provided on the one rotary shaft, and balls are in contact with the one rotary shaft.

2. The drive apparatus for a vehicle according to claim 1, wherein, in a vehicle-mounted state, the one rotary shaft is arranged uppermost in a vertical direction among the first rotary shaft, the second rotary shaft, and the third rotary shaft.

3. The drive apparatus for a vehicle according to claim 1, wherein:
the first motive power source is an engine;
the first rotary shaft is an input shaft coupled to the engine;
the second motive power source is a motor;
the second rotary shaft is a rotor coupling shaft coupled to a rotor of the motor;
the third rotary shaft is an output shaft of a differential apparatus that splits the motive power transmitted from each of the engine and the motor between the drive wheels; and
the one rotary shaft is the rotor coupling shaft.

4. The drive apparatus for a vehicle according to claim 3, further comprising
on the input shaft, an electric transmission mechanism that has a differential mechanism that is coupled such that the engine is able to transmit motive power and a motor for differential that is coupled to the differential mechanism so as to be able to transmit motive power, a differential state of the differential mechanism being controlled by an operation state of the motor for differential being controlled, the drive apparatus further comprising
a transmission apparatus that has a counter shaft as a fourth rotary shaft to transmit each of the motive power from the first rotation member and the motive power from the second rotation member to the third rotation member, wherein:
the first rotation member is an output gear of the electric transmission mechanism;
the second rotation member is a deceleration gear relatively non-rotatably fixed to the rotor coupling shaft;
the third rotation member is an input gear of the differential apparatus; and
in a vehicle-mounted state, the rotor coupling shaft is arranged uppermost in a vertical direction among the input shaft, the rotor coupling shaft, the output shaft, and the counter shaft.

5. The drive apparatus for a vehicle according to claim 4, wherein the transmission apparatus includes:
a first gear that is relatively non-rotatably fixed to the counter shaft and meshes with each of the output gear and the deceleration gear; and
a second gear that has a smaller diameter than the first gear and meshes with the input gear.
